(19) United States
(12) Patent Application Publication
(10) Pub. No.: US 2026/0175899 A1
(43) Pub. Date: Jun. 25, 2026

(54) VEHICLE STEERING COLUMN AND VEHICLE INCLUDING THE SAME

(71) Applicant: HL MANDO CORPORATION, Gyeonggi-do (KR)

(72) Inventor: Hyunbi KWON, Gyeonggi-do (KR)

(21) Appl. No.: 19/406,872

(22) Filed: Dec. 2, 2025

(30) Foreign Application Priority Data
Dec. 24, 2024 (KR) 10-2024-0194920

(51) Int. Cl. B62D 1/181

(52) U.S. Cl. CPC B62D 1/181

(57) ABSTRACT

A vehicle steering column comprises an upper tube in which a steering shaft is rotatably coupled, a lower tube into which the upper tube is inserted, the lower tube having a through-hole formed through an outer peripheral surface and an inner peripheral surface of the lower tube, a support member coupled between the upper tube and the lower tube and configured to support a sliding motion of the upper tube, and an adjustment member coupled to the through-hole and configured to support the support member in a radial direction.

### CROSS-REFERENCE TO RELATED APPLICATIONS

This application claims the priority of Korean Patent Application No. 10-2024-0194920 filed on Dec. 24, 2024, in the Korean Intellectual Property Office, the disclosure of which is incorporated herein by reference.

### BACKGROUND

### Field

The present embodiments relate to a vehicle steering column and a vehicle including the same.

### Description of the Related Art

In general, a vehicle steering column is installed forward of a driver seat in a vehicle and configured to transmit a steering force, which is generated by a steering wheel, to road wheels, and the vehicle steering column includes telescopic and tilting functions in order to adjust a position of the steering wheel in accordance with a driver's physical characteristics.

Further, the driver may adjust a degree to which the steering wheel protrudes and an inclination angle of the steering wheel suitable for the driver's height or body type by using the telescopic and tilting functions, thereby smoothly performing a steering operation.

However, the vehicle steering column in the related art has a problem of noise and vibration caused by an increase in friction between upper and lower tubes during a telescopic operation, and there is a problem in that a sway of the steering wheel caused by an inadvertent motion occurring at a predetermined angle with respect to a telescopic operation direction results in unpleasantness for the driver.

Accordingly, there is a growing need for research on a vehicle steering column capable of suppressing the occurrence of noise and vibration during a telescopic operation and improving an operational feel of the telescopic operation perceived by a driver.

### SUMMARY

The present embodiments have been made keeping in mind the above-mentioned background, and the present embodiments relate to a vehicle steering column and a vehicle, the vehicle steering column being capable of preventing noise and vibration during a telescopic operation performed by a driver and preventing an inadvertent motion occurring at a predetermined angle with respect to a telescopic operation direction, thereby improving an operational feel of the telescopic operation perceived by the driver.

According to the present embodiments, it is possible to provide a vehicle steering column including an upper tube to which a steering shaft is rotatably coupled, a lower tube in which at least a part of the upper tube is inserted, the lower tube having a through-hole, a support member positioned between the upper tube and the lower tube and configured to support an axial sliding motion of the upper tube, and an adjustment member coupled to the through-hole of the lower tube and supporting the support member in a radial direction.

In addition, according to the present embodiments, it is possible to provide a vehicle including: an upper tube to which a steering shaft is rotatably coupled; a lower tube in which at least a part of the upper tube is inserted, the lower tube having a through-hole; a support member positioned between the upper tube and the lower tube and configured to support an axial sliding motion of the upper tube; an adjustment member coupled to the through-hole of the lower tube and supporting the support member in a radial direction; a torque sensor configured to detect rotation of the steering shaft and transmit an input signal to a controler; and a pinion drive motor configured to operate a pinion shaft in response to an output signal transmitted from the controller.

In addition, according to the present embodiments, it is possible to provide a vehicle including: an upper tube to which a steering shaft is rotatably coupled; a lower tube in which at least a part of the upper tube is inserted, the lower tube having a through-hole; a support member positioned between the upper tube and the lower tube and configured to support an axial sliding motion of the upper tube; an adjustment member coupled to the through-hole of the lower tube and supporting the support member in a radial direction; a pinion shaft operably connected to the steering shaft; and a rack bar operably coupled to the pinion shaft.

According to the present embodiments, it is possible to prevent noise and vibration occurring during the telescopic operation performed by the driver and prevent an inadvertent motion occurring at a predetermined angle with respect to the telescopic operation direction, thereby improving the operational feel of the telescopic operation perceived by the driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating a part of a vehicle steering column according to the present embodiments;

FIGS. 2 to 4 are exploded perspective views illustrating a part of the vehicle steering column according to the present embodiments;

FIG. 5 is a perspective view illustrating a part of the vehicle steering column according to the present embodiments;

FIGS. 6 to 10 are cross-sectional views illustrating a part of the vehicle steering column according to the present embodiments; and

FIGS. 11 and 12 are schematic views illustrating a vehicle according to the present embodiments.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

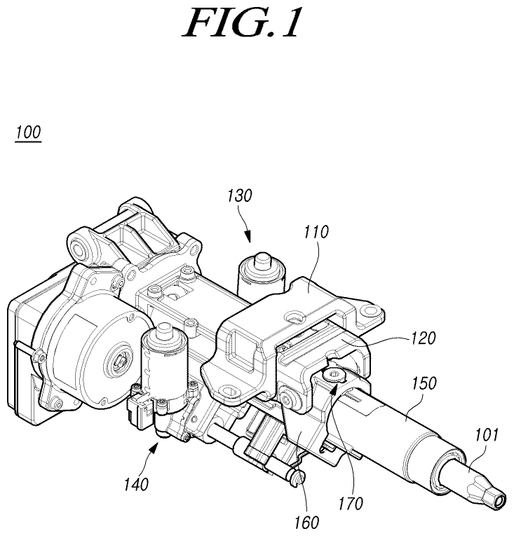

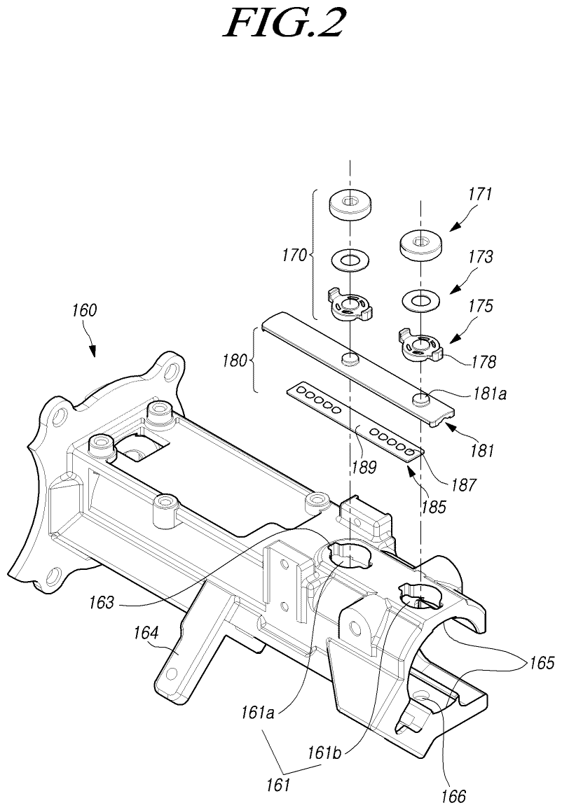

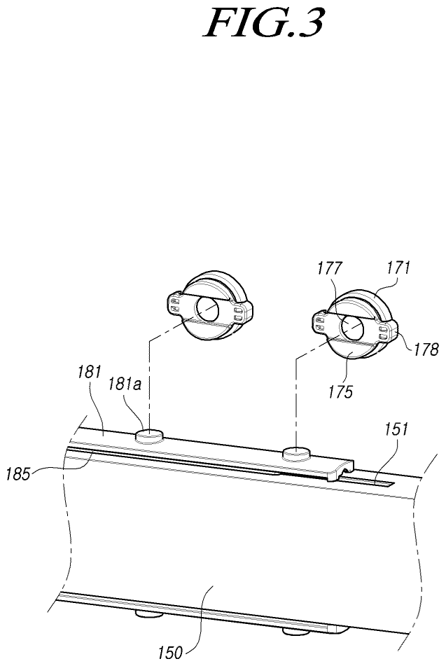

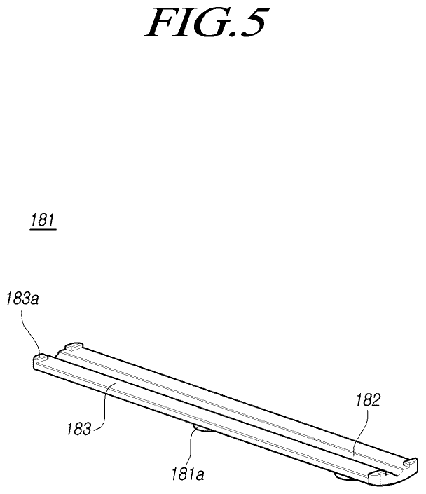

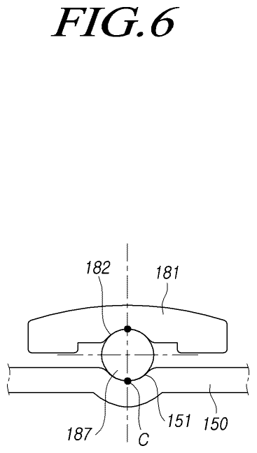

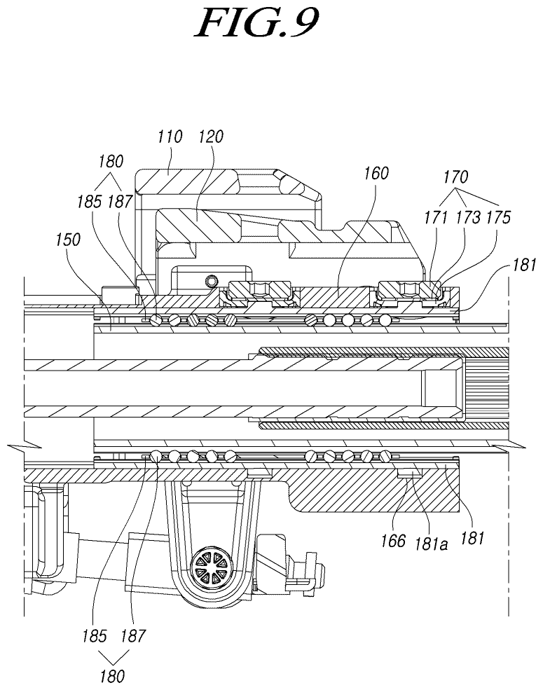

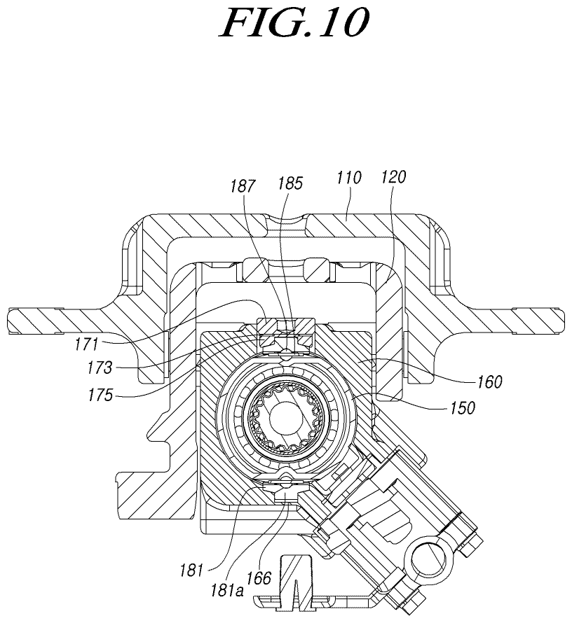

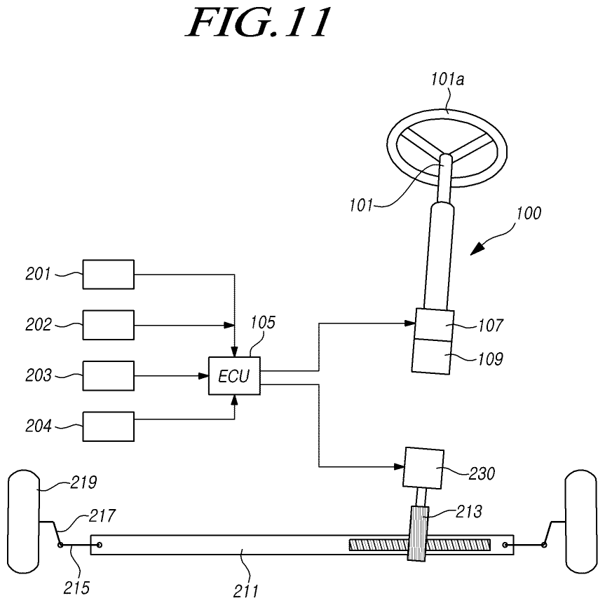

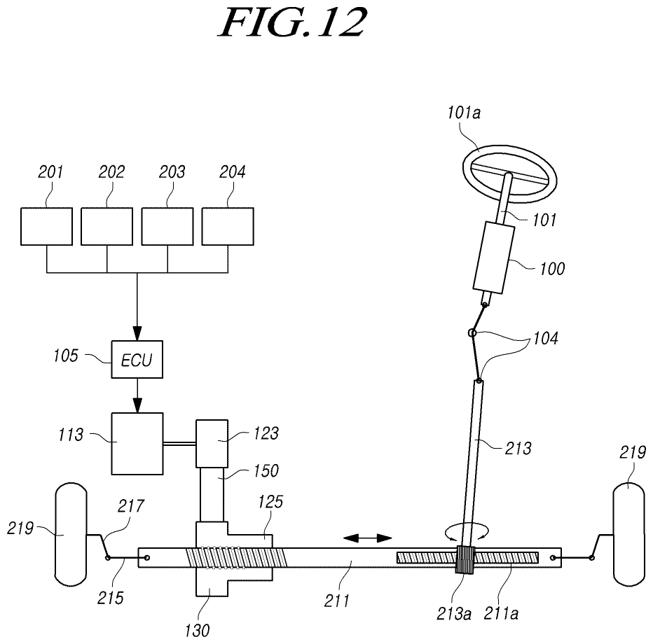

FIG. 1 is a perspective view illustrating a part of a vehicle steering column according to the present embodiments, FIGS. 2 to 4 are exploded perspective views illustrating a part of the vehicle steering column according to the present embodiments, FIG. 5 is a perspective view illustrating a part of the vehicle steering column according to the present embodiments, FIGS. 6 to 10 are cross-sectional views illustrating a part of the vehicle steering column according to the present embodiments, and FIGS. 11 and 12 are schematic views illustrating a vehicle according to the present embodiments.

First, the present embodiments will be described with reference to FIGS. 1 to 10.

According to the present embodiments, it is possible to provide a vehicle steering column 100 including an upper tube 150 to which a steering shaft 101 is rotatably coupled, a lower tube 160 in which at least a part of the upper tube 150 is inserted, the lower tube 160 having through-holes 161, a member 180 positioned between the upper tube 150 and the lower tube 160 and configured to support an axial sliding motion of the upper tube 150, and adjustment members 170 coupled to the through-holes 161 of the lower tube and supporting the support member 180 in a radial direction.

The vehicle steering column 100 according to the present embodiments includes the steering shaft 101, the upper tube 150, the lower tube 160, a mounting bracket 110, a tilting bracket 120, a telescopic drive part 140, a tilting drive part 130, and the like.

The steering shaft 101 is coupled to a steering wheel configured to be manipulated by a driver and transmits a steering force while rotating together with the steering wheel.

The steering shaft 101 is rotatably supported and coupled in the upper tube 150 formed in a hollow shape.

The upper tube 150 is inserted and coupled into an end of the lower tube 160 and performs a telescopic motion in an axial direction. The mounting bracket 110 configured to fix the steering column 100 to a vehicle body is coupled to an outer side of the lower tube 160.

In the steering column 100, in order to maintain a constant frictional force between the upper tube 150 and the lower tube 160 and suppress the occurrence of noise and vibration during the telescopic operation performed by the driver, the support member 180 is coupled between the upper tube 150 and the lower tube 160, and the adjustment members 170 are coupled to the lower tube 160 and support the support member 180.

That is, the through-holes 161, which are formed through the outer peripheral surface and the inner peripheral surface of the lower tube 160, are formed at one end of the lower tube 160 into which the upper tube 150 is inserted. The through-holes 161a and 161b may be provided as two or more through-holes 161a and 161b disposed to be spaced apart from one another in the axial direction.

Further, the adjustment members 170 may be respectively coupled to the through-holes 161a and 161b spaced apart from each other in the axial direction and support one side and the other side of the support member 180 based on the axial direction.

The support member 180 includes a track guide 181 spaced apart from an outer peripheral surface of the upper tube 150 and fixed to the adjustment members 170 coupled to the through-hole 161 of the lower tube 160, and a tube support member 185 supporting the outer peripheral surface of the upper tube 150 and configured to be slidable in the axial direction along the track guide 181 when the upper tube 150 slides.

The track guide 181 and the tube support member 185 are formed to be elongated in the axial direction in which the upper tube 150 slides. The track guide 181 is fixed to the lower tube 160 by the adjustment members 170, and the tube support member 185 slides in the axial direction together with the upper tube 150.

A guide seating groove 165, in which the track guide 181 is seated, is provided in the inner peripheral surface of the lower tube 160. In the present embodiments, an example is illustrated in which the guide seating grooves 165 are respectively provided at positions that face each other.

At least a part of the through-hole 161 of the lower tube 160 is positioned to be overlapped with the guide seating groove 165 formed on the inner surface of the lower tube 160. In this case, only the support member 180 may be coupled to the guide seating groove 165 provided at the position that faces the through-hole 161, and the adjustment member 170 is not coupled to the guide seating groove 165.

The tube support member 185 may include rotatable supports 187 rotatably disposed between the upper tube 150 and the track guide 181, and a support plate 189 to which the rotatable support 187 is rotatably coupled.

The rotatable support 187 has a spherical shape or a roller shape. In the present embodiment, an example is illustrated in which the rotatable support 187 is formed in a spherical shape.

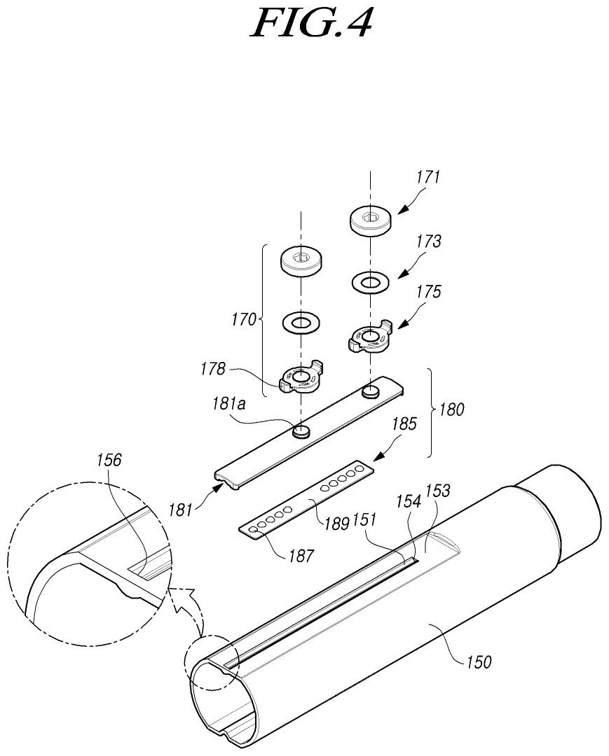

As illustrated in FIG. 4, the rotatable supports 187 each having a spherical shape are rotatably disposed in a tube rail groove 151, formed on the outer surface of the upper tube 150. The tube rail groove 151 is formed in the axial direction in a flat surface portion 153 formed to make it easy to mount and slide the tube support member 185.

Stepped projections 154 and 156 are provided at two opposite ends of the tube rail groove 151 to prevent separation of the rotatable supports 187.

As illustrated in FIG. 6, the tube rail groove 151 has a partially cylindrical shape elongated in the axial direction, and a radius of a cross-section of the tube rail groove 151 is larger than a radius of the rotatable support 187.

In this case, an outer peripheral surface of the rotatable support 187 and the tube rail groove 151 are in point contact with each other at one point C, which may satisfy a condition most suitable for a rollable structure and minimize noise and frictional force.

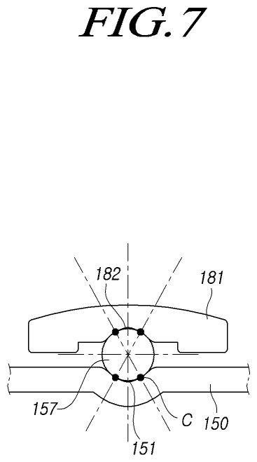

In addition, as illustrated in FIG. 7, the tube rail groove 151 has a partially cylindrical shape elongated in the axial direction and having a cross-section having an arc shape.

In this case, the outer peripheral surface of the rotatable support 187 and the tube rail groove 151 are in point contact with each other at two points C, which may prevent the occurrence of a clearance between the rotatable support 187 and the tube rail groove 151 and reduce noise.

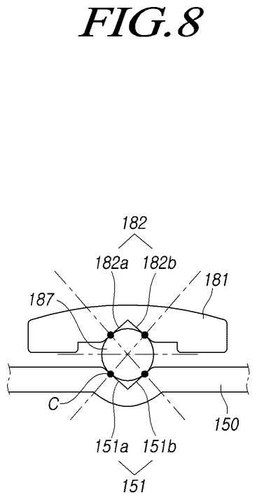

In addition, as illustrated in FIG. 8, the tube rail groove 151 may be elongated in the axial direction, and a cross-section of the tube rail groove 151 has a first inclined surface 151a supporting one point of the outer surface of the rotatable support 187, and a second inclined surface 151b supporting another point of the outer surface of the rotatable support 187 and connected to the first inclined surface 151a.

In this case, operations of processing and managing the contact surface with the rotatable support 187 may be facilitated, and the outer peripheral surface of the rotatable support 187 and the tube rail groove 151 are in point contact with each other at two points C, which may prevent the occurrence of a clearance between the rotatable support 187 and the tube rail groove 151 and reduce noise.

With reference to FIG. 5, the rotatable supports 187 are rotatably disposed in a guide rail groove 182d, which is formed on an inner surface 183 of the track guide 181 of the support member 180. End protrusions 183a configured to prevent the separation of the tube support member 185 may be provided at two opposite ends of the guide rail groove 182.

Therefore, the tube support member 185 is supported by the end protrusions 183a even though the tube support member 185 slides in the axial direction together with the upper tube 150, such that the tube support member 185 may be prevented from being separated in the axial direction, and a sliding limit position may be maintained.

As illustrated in FIG. 6, the guide rail groove 182 has a partially cylindrical shape elongated in the axial direction, and a radius of a cross-section of the guide rail groove 182 is larger than a radius of the rotatable support 187.

In this case, the outer peripheral surface of the rotatable support 187 and the guide rail groove 182 are in point contact with each other at one point, which may satisfy a condition most suitable for the rollable structure and minimize noise and frictional force.

In addition, as illustrated in FIG. 7, the guide rail groove 182 has a partially cylindrical shape elongated in the axial direction and having a cross-section having an arc shape.

In this case, the outer peripheral surface of the rotatable support 187 and the guide rail groove 182 are in point contact with each other at two points, which may prevent the occurrence of a clearance between the rotatable support 187 and the guide rail groove 182 and reduce noise.

As illustrated in FIG. 8, the guide rail groove 182 may be elongated in the axial direction, and a cross-section of the guide rail groove 182 has a first inclined surface 182a supporting one point of the outer surface of the rotatable support 187, and a second inclined surface 182b supporting another point of the outer surface of the rotatable support 187 and connected to the first inclined surface 182a.

In this case, the operations of processing and managing the contact surface with the rotatable support 187 may be facilitated, and the outer peripheral surface of the rotatable support 187 and the guide rail groove 182 are in point contact with each other at two points, which may prevent the occurrence of a clearance between the rotatable support 187 and the tube rail groove 151 and reduce noise.

With reference to FIGS. 2 to 4 together, the adjustment member 170 may include a guide support 175 coupled to the through-hole 161 of the lower tube 160 and supporting the track guide 181 of the support member 180, a fixing support 171 screw-coupled to the through-hole 161 of the lower tube 160 and supporting the guide support 175, and an elastic structure 173 disposed between the guide support 175 and the fixing support 171 to provide an elastic restoring force between the guide support 175 and the fixing support 171.

Extension protrusions 178 protrude from one side and another side of the guide support 175, and the through-hole 161 of the lower tube 160 has extension holes 163 recessed from an inner surface of the through-hole 161, and the extension protrusions 178 are inserted in the extension holes 163 formed at the through-holes 161 of the lower tube 160.

Further, the rack guide 180 of the support member 180 has a coupling protrusion 181a protruding from an outer surface of the track guide 181 of the support member 180, and the guide support 175 of the adjustment member 170 has a coupling groove 177 in which the coupling protrusion 181a of the track guide of the support member 180 is inserted.

Therefore, the guide support 175 may support the track guide 181 at an exact position without being rotated or separated even though a load is transmitted to the track guide 181 as the tube support member 185 moves in the axial direction together with the upper column.

An example is illustrated in which the elastic structure 173 is formed in an annular cone shape. However, the present disclosure is not necessarily limited thereto. Any component, which generates an elastic force in two opposite upward and downward directions between the guide support 175 and the fixing support 171, may be coupled.

With reference to FIG. 11 together with FIGS. 1 to 10, a vehicle according to the present embodiments may include the upper tube 150 to which the steering shaft 101 is rotatably coupled, the lower tube 160 in which at least a part of the upper tube 150 is inserted, the lower tube 160 having the through-holes 161, the support member 180 positioned between the upper tube 150 and the lower tube 160 and configured to support the axial sliding motion of the upper tube 150, the adjustment members 170 coupled to the through-holes 161 of the lower tube 160 and o supporting the support member 180 in the radial direction, a torque sensor 202 configured to detect rotation of the steering shaft 101 and transmit an input signal to a controller 105, and a pinion drive motor 230 configured to operate a pinion shaft 213 in response to an output signal transmitted from the controller 105.

In this case, because the upper tube 150, the lower tube 160, the support member 180, and the adjustment member 170 are identical to those of the above-mentioned steering column 100, and a detailed description thereof will be omitted.

With reference to FIG. 11, the vehicle according to the present embodiments is provided with a steer-by-wire steering system and configured such that an angle sensor 201 and the torque sensor 202 configured to detect a manipulation when the driver manipulates a steering wheel 101a send electrical signals to the controller 105, and the controller 105 operates a steering wheel motor 107 and a pinion shaft motor 230.

The controller 105 controls the steering wheel motor 107 and the pinion shaft motor 230 based on the electrical signals transmitted from the angle sensor 201 and the torque sensor 202 and electrical signals transmitted from several sensors mounted in the vehicle.

The steering wheel motor 107 is connected to a speed reducer (not illustrated) configured to reduce a rotational speed of the motor. During normal traveling, the steering wheel motor 107 provides a reaction force to the steering wheel 101a so that the driver may perceive a steering reaction force in an opposite direction when the driver manipulates the steering wheel 101a. During autonomous driving, the steering is performed under the control of the controller 105 without intervention of the driver's intention.

The pinion shaft motor 230 is configured to steer two opposite wheels 219 by means of tie rods 215 and knuckle arms 217 by sliding a rack bar 211 connected to the pinion shaft 213.

However, for convenience of description, FIG. 11 illustrates an example in which the angle sensor 201, the torque sensor 202, a vehicle speed sensor 203 for transferring steering information to the controller 105, and a wheel rotation angle sensor 204 are provided. However, a motor position sensor, various types of radar and lidar, image sensors, such as a camera, and the like may be provided, and a detailed description thereof will be omitted.

In the vehicle provided with the steer-by-wire steering system, the steering wheel 101a and the wheel 219 are not mechanically connected. Therefore, a mechanical restriction is required to stop the rotation of the steering wheel 101a at a predetermined angle when the driver manipulates the steering wheel 101a.

Therefore, a rotation angle restriction member 109 may be provided to mechanically restrict a rotation angle of the steering wheel 101a to prevent the steering wheel 101a from rotating any further in case that the rotation of the wheel 219 reaches a maximum point (the steering wheel 101a or the wheel 219 is in a full-turn state in a general steering system).

With reference to FIG. 12 together with FIGS. 1 to 10, the vehicle according to the present embodiments may include the upper tube 150 to which the steering shaft 101 is rotatably coupled, the lower tube 160 in which at least a part of the upper tube 150 is inserted, the lower tube 160 having the through-holes 161, the support member 180 positioned between the upper tube 150 and the lower tube 160 and configured to support the axial sliding motion of the upper tube 150, the adjustment members 170 coupled to the through-holes 161 of the lower tube 160 and supporting the support member 180 in the radial direction, the pinion shaft 213 operably connected to the steering shaft 101, and the rack bar 211 operably coupled to the pinion shaft 213.

In this case, because the upper tube 150, the lower tube 160, the support member 180, and the adjustment member 170 are identical to those of the above-mentioned steering column 100, and a detailed description thereof will be omitted.

With reference to FIG. 12, the vehicle according to the present embodiments is provided with a rack-driving type power-assisted steering system and configured such that the torque sensor 202 is coupled to one side of the steering shaft 101 connected to the steering wheel 101a, and electrical signals are sent to the motor from the torque sensor 202, the angle sensor 201, and the vehicle speed sensor 203, which detect a manipulation when the driver manipulates the steering wheel 101a, thereby steering the two opposite wheels 219 by means of a tie rod.

In the present embodiments, the steering shaft 101 at an upper end is connected to the pinion shaft 213 at a lower end by means of a universal joint 104, and the steering is performed by a rack-pinion mechanism including a pinion 213a and a rack gear 211a.

In this case, driving power of a motor 113 operated by the controller 105 is transmitted to a ball nut 125 through the motor 113 and a belt 250. The rack bar 211, which is coupled to the ball nut 125 by means of a ball, slides in the axial direction, the tie rods 215 are coupled to two opposite sides of the rack bar 211, and the tie rods 215 are coupled to the knuckle arms 217 connected to the wheels 219 to steer the wheels 219.

A motor pulley 123, which is connected to a shaft of the motor 113, and a nut pulley 130, which is connected to the ball nut 125, are disposed in parallel with each other. The belt 250 is coupled to the motor pulley 123 and the nut pulley 130 and transmits a rotational force of the motor 113 to the rack bar 211 through the ball nut 125, and the rack bar 211 is moved leftward or rightward by the operation of the ball nut 125, thereby generating steering assistive power.

Further, the electrical signal generated from the torque sensor 202 is sent to the controller 105. The controller 105 controls the motor 113 based on the electrical signals transmitted from the torque sensor 202 and the electrical signals transmitted from the vehicle speed sensor 203, the wheel rotation angle sensor 204, and the like mounted in the vehicle.

However, for convenience of description, FIG. 12 illustrates an example in which the angle sensor 201, the torque sensor 202, a vehicle speed sensor 203 for transferring steering information to the controller 105, and a wheel rotation angle sensor 204 are provided. However, a motor position sensor, various types of radar and lidar, image sensors, such as a camera, and the like may be provided, and a detailed description thereof will be omitted.

In addition, as described above, the tube support member 185 may include the rotatable supports 187 supported on the upper tube 150 and the track guide 181 and configured to rotate, and the support plate 189 to which the rotatable support 187 is rotatably coupled.

According to the present embodiments having the above-mentioned shapes and structures, it is possible to prevent noise and vibration occurring during the telescopic operation performed by the driver and prevent an inadvertent motion occurring at a predetermined angle with respect to the telescopic operation direction, thereby improving the operational feel of the telescopic operation perceived by the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A vehicle steering column comprising:
an upper tube to which a steering shaft is rotatably coupled;
a lower tube in which at least a part of the upper tube is inserted, the lower tube having a through-hole;
a support member positioned between the upper tube and the lower tube and configured to support an axial sliding motion of the upper tube; and
an adjustment member coupled to the through-hole of the lower tube and supporting the support member in a radial direction.

2. The vehicle steering column of claim 1, wherein the support member comprises:
a track guide spaced apart from an outer surface of the upper tube and fixed to the adjustment member coupled to the through-hole of the lower tube; and
a tube support member supporting the outer surface of the upper tube and configured to be slidable in an axial direction along the track guide when the upper tube slides.

3. The vehicle steering column of claim 2, wherein the track guide is disposed in a guide seating groove formed on an inner surface of the lower tube.

4. The vehicle steering column of claim 3, wherein at least a part of the through-hole of the lower tube is positioned to be overlapped with the guide seating groove formed on the inner surface of the lower tube.

5. The vehicle steering column of claim 2, wherein the tube support member comprises:
a rotatable support rotably disposed between the upper tube and the track guide; and
a support plate to which the rotatable support is rotatably coupled.

6. The vehicle steering column of claim 5, wherein the rotatable support has a spherical shape.

7. The vehicle steering column of claim 6, wherein at least a part of the rotatable support is rotatably disposed in a tube rail groove which is formed on the outer surface of the upper tube.

8. The vehicle steering column of claim 7, wherein the tube rail groove has a partially cylindrical shape elongated in the axial direction, and a radius of a cross-section of the tube rail groove is larger than a radius of the rotatable support.

9. The vehicle steering column of claim 7, wherein the tube rail groove has a partially cylindrical shape elongated in the axial direction and having a cross-section having an arc shape.

10. The vehicle steering column of claim 7, wherein the tube rail groove is elongated in the axial direction, and a cross-section of the tube rail groove has a first inclined surface supporting one point of an outer surface of the rotatable support and a second inclined surface supporting another point of the outer surface of the rotatable support and connected to the first inclined surface.

11. The vehicle steering column of claim 6, wherein at least a part of the rotatable support is rotatably disposed in a guide rail groove which is formed on an inner surface of the track guide of the support member.

12. The vehicle steering column of claim 11, wherein the guide rail groove has a partially cylindrical shape elongated in the axial direction, and a radius of a cross-section of the guide rail groove is larger than a radius of the rotatable support.

13. The vehicle steering column of claim 11, wherein the guide rail groove has a partially cylindrical shape elongated in the axial direction and having a cross-section having an arc shape.

14. The vehicle steering column of claim 11, wherein the guide rail groove is elongated in the axial direction, and a cross-section of the guide rail groove has a first inclined surface supporting one point of an outer surface of the rotatable support and a second inclined surface supporting another point of the outer surface of the rotatable support member and connected to the first inclined surface.

15. The vehicle steering column of claim 2, wherein the adjustment member comprises:
a guide support coupled to the through-hole of the lower tube and supporting the track guide of the support member;
a fixing support screw-coupled to the through-hole of the lower tube and supporting the guide support; and
an elastic structure disposed between the guide support and the fixing support to provide an elastic restoring force between the guide support and the fixing support.

16. The vehicle steering column of claim 15, wherein:
extension protrusions protrude from one side and another side of the guide support,
the through-hole of the lower tube has extension holes recessed from an inner surface of the through-hole, and
the extension protrusions of the guide support are inserted in the extension holes formed at the through-holes of the lower tube.

17. The vehicle steering column of claim 15, wherein the track guide of the support member has a coupling protrusion protruding from an outer surface of the track guide of the support member, and the guide support of the adjustment member has a coupling groove in which the coupling protrusion of the track guide of the support member is inserted.

18. A vehicle comprising:
an upper tube to which a steering shaft is rotatably coupled;
a lower tube in which at least a part of the upper tube is inserted, the lower tube having a through-hole;
a support member positioned between the upper tube and the lower tube and configured to support an axial sliding motion of the upper tube;
an adjustment member coupled to the through-hole of the lower tube and supporting the support member in a radial direction;
a torque sensor configured to detect rotation of the steering shaft and transmit an input signal to a controller; and
a pinion drive motor configured to operate a pinion shaft in response to an output signal transmitted from the controller.

19. A vehicle comprising:
an upper tube to which a steering shaft is rotatably coupled;
a lower tube in which at least a part of the upper tube is inserted, the lower tube having a through-hole;
a support member positioned between the upper tube and the lower tube and configured to support an axial sliding motion of the upper tube;
an adjustment member coupled to the through-hole of the lower tube and supporting the support member in a radial direction;
a pinion shaft operably connected to the steering shaft; and
a rack bar operably coupled to the pinion shaft.

20. The vehicle of claim 19, wherein the support member comprises:
a rotatable support rotatably disposed between the upper tube and a track guide; and
a support plate to which the rotatable support is rotatably coupled.
